SEQUENCE LISTING (7 sequences)

SEQ ID NO: 1 - DNA, 24 bp, Artificial Sequence
  synthetic construct
aaaaaaaaaaaagggggggggggg

SEQ ID NO: 2 - DNA, 16 bp, Artificial Sequence
  synthetic construct
gcttatcgagctttcg

SEQ ID NO: 3 - DNA, 16 bp, Artificial Sequence
  synthetic construct
atcgatcgagctgcaa

SEQ ID NO: 4 - DNA, 16 bp, Artificial Sequence
  synthetic construct
atcagtgcaggagcta

SEQ ID NO: 5 - DNA, 16 bp, Artificial Sequence
  synthetic construct
cgaaagctcgataagc

SEQ ID NO: 6 - DNA, 16 bp, Artificial Sequence
  synthetic construct
ttgcagctcgatcgat

SEQ ID NO: 7 - DNA, 16 bp, Artificial Sequence
  synthetic construct
tagctcctgcactgat

(19) United States
(12) Patent Application Publication
(10) Pub. No.: US 2011/0046013 A1
(43) Pub. Date: Feb. 24, 2011

(54) METHOD TO GENERATE BIOMOLECULAR MICRO- AND NANO-PATTERNS BY PARTICLE PRINTING LITHOGRAPHY

(76) Inventors: Yong CHEN, Sherman Oaks, CA (US); Suxian Huang, Los Angeles, CA (US)

Correspondence Address: MORRISON & FOERSTER LLP, 12531 HIGH BLUFF DRIVE, SUITE 100, SAN DIEGO, CA, 92130-2040, US

(21) Appl. No.: 12/840,095

(22) Filed: Jul. 20, 2010

Related U.S. Application Data
(60) Provisional application No. 61/227,372, filed on Jul. 21, 2009.

(51) Int. Cl. C40B 50/18; C40B 40/00

(52) U.S. Cl. 506/13; 506/32

(57) ABSTRACT

Methods for preparing useful patterns of biomolecules on solid supports employ particle printing lithography techniques whereby suspensions of different bioconjugates are loaded onto portions of a master pattern formed by a series of portions in a support that are compatible with an attractive force to which the bioconjugates respond. The master pattern of the bioconjugates can then be transferred to a biocompatible matrix for biological and medical applications.

### RELATED APPLICATION

This application claims benefit of U.S. application Ser. No. 61/227,372 filed 21 Jul. 2009. The contents of this application are incorporated herein by reference.

### TECHNICAL FIELD

The invention relates to a lithographic method for generating micro- or nano-patterns of biomolecules by controlling locations and amounts of a multiplicity of different biomolecules. More particularly, the invention is directed to a method to obtain predetermined patterned surfaces for bioanalysis, diagnostics, drug delivery, gene delivery, and/or cell differentiation.

### BACKGROUND ART

The construction of microarrays and use of such microarrays in complex analysis has been employed for almost 20 years. Various techniques for providing such arrays are known in the art, with varying levels of efficiency, compactness, and sensitivity. Such microarrays or nanoarrays are typically used to analyze compositions containing proteins, nucleic acids, small molecules, and the like. There is an extensive literature on preparing the micro or nanoarrays, and the use of lithographic techniques has been exploited. For example, dip pen approaches, nanografting, and electron beam lithography have been used. All of these are serial point-to-point techniques which are limited by their low speed. Nanocontact printing and nanoimprint lithography have been used to generate biomolecular nanopatterns, but it is difficult to generate heterogeneous patterns with a multiplicity of different biomolecules using these techniques. Other techniques, such as bottom-up self-assembled particles, copolymers and the use of oligonucleotides to bind the relevant biomolecules, have also been used.

The present invention offers an efficient, scalable technique to generate complex patterns of biomolecules which technique controls locations and amounts of a multiplicity of different biomolecules.

### DISCLOSURE OF THE INVENTION

The present invention is a high-speed, high-throughput, low-cost technique to generate microscale or nanoscale patterns composed of multiple different biomolecules. Distinct biomolecules are optionally conjugated with micro- or nano-particles to form bioconjugates, and the particles or biomolecules can be selectively assembled onto a template surface to form micro- or nano-scale patterns with controllable biomolecular types, densities, and amounts on each pattern. The biomolecular micro- or nano-patterns can be printed from the resulting template to a biocompatible matrix or product film for various biological and medical applications.

Thus, in one aspect, the invention is directed to a method to provide a template which comprises a support having a multiplicity of portions arranged in a master pattern with a multiplicity of different biomolecules associated with the different portions of the support.

The different biomolecules are provided in the form of biomolecules coupled to nanoparticles or microparticles to form bioconjugates. The bioconjugates are coupled to the various portions in the master pattern by virtue of an attractive force applied to these portions and to which the bioconjugates or biomolecules are responsive. The attractive force may be an electrical force, a magnetic force, a hydrophilic interaction, hydrophobic interaction, molecular interaction, or combinations thereof.

The bioconjugates may be responsive by virtue of the nature of the particles, but the inherent properties of the biomolecules may themselves provide the appropriate response. For example, if the attractive force is an electrical force, a negatively charged molecule, such as DNA may provide the response to a positive gradient applied to the relevant portion. In any case, magnetic and electrically charged nanoparticles and microparticles are well known in the art as will further be described below.

There are a number of ways that the process itself may be performed. For suitable dimensions of the master pattern, microfluidics may provide a means whereby suspensions containing the various bioconjugates can be individually directed to individual portions simultaneously. Alternatively, the bioconjugates may be supplied sequentially by providing a first suspension containing a first bioconjugate which is then subjected to an attractive force applied to a first portion of the micropattern. Any bioconjugates or biomolecules that are not entrapped are then washed away, and a second suspension containing a second bioconjugate is supplied and an attractive force applied to a second portion of the micropattern, and so on.

These methods apply regardless of the choice of electrical, magnetic, hydrophilic or hydrophobic interactions, or molecular interactions. In the embodiments wherein a magnetic field is used as the attractive force, for preparing templates that will contain coated portions with diameters of the order of millimeters, as opposed to microns or nanometers, the dimensions of the coated portions may be determined without pre-patterning simply by applying magnetic fields only to certain portions of the support. Again, either simultaneous application through appropriate individual channels to individual portions or sequential application to the various portions can be employed. In the embodiments wherein a hydrophilic or hydrophobic interaction is used as the attractive force, the wetting property of the surface is alternated between hydrophilic and hydrophobic. Electrowetting is a method to change the surface wetting property by an applied electric field. In the embodiments wherein the molecular attraction is used as the force, templates contain portions containing molecules that interact or bind specifically to supplied bioconjugates. These may be members of specific binding pairs such as antibodies or fragments thereof and antigens, complementary oligonucleotides, ligand receptor pairs and the like.

In another aspect, the invention is directed to transferring a pattern of biomolecules contained on a template as described above (comprising a support composed of multiplicity of different biomolecule-conjugates or biomolecules entrapped at an upper surface of each of a multiplicity of portions of the support) to a matrix, which method comprises casting said matrix onto the upper surface of said biomolecule conjugate-populated support or template, effecting transfer into the matrix, and entrapping the patterned biomolecule conjugates or biomolecules into a product film formed by said matrix and then removing said film.

The matrix can be crosslinkable polymer or hydrogel, which is cast in an un-crosslinked form onto the upper surface of the biomolecule conjugate-populated support. Bonding interaction between the bioconjugates or biomolecules and matrix then occurs. The forces between the matrix and the particles are stronger than the forces between the particles and the portions on the template. The bioconjugates or biomolecules are entrapped by crosslinking (chemical or physical) the polymer or hydrogel by UV exposure, heat, physical association or chemical reactions to form the product film. When the film is separated from the support, the bioconjugates or biomolecules in the pattern on the template are retained in the product film. The template containing the master pattern can then be reused in the process outlined above.

In one embodiment, transferring a pattern of biomolecules contained on a template to a matrix can be achieved by applying an electric field. Portions of the template are made of conductive materials. After the template is prepared, it is covered by a matrix, such as a chemically crosslinked, or physically associated polymer or hydrogel, for example, an agarose gel. The matrix can also be an uncrosslinked or unassociated polymer or hydrogel, and after being cast onto the template, the matrix is crosslinked or associated. A conductive plate is then added as a counter electrode to generate parallel electric fields inside the matrix. The matrix is sandwiched between the portions and the counter electrode, creating a gel electrophoresis apparatus. The bioconjugates migrate into the matrix and also migrate inside the matrix under the influence of the electric field.

In another embodiment, transferring a pattern of biomolecules contained on a template to a matrix can be achieved by pressing a solid plate onto the top surface of the template. After the bioconjugates attached to the solid plate by chemical crosslinking or physical association, the plate is removed from the template and the bioconjugates or biomolecules in the pattern are transferred to the said solid plate.

In another aspect, the invention is directed to the products of the processes set forth above and to the combination of these two processes.

Both the product film and the template may be used for analysis of samples by detecting binding of components of these samples to the various biomolecules displayed according to the master pattern using techniques well known in the art. For example, if the biomolecules are a variety of proteins and the product film is used to analyze a fluid for human antibodies to these proteins, binding of any human antibodies from, the sample could be detected at the various locations by use of antihuman antibodies provided with labels.

Both the bioconjugates or biomolecules patterned on the portions of the substrate and the bioconjugates or biomolecules patterned in the matrix (after transfer) can be used for bioanalysis, diagnostics, drug delivery, gene delivery, cell differentiation and morphogenesis, tissue regeneration, and the like.

### BRIEF DESCRIPTION OF THE DRAWINGS

FIGS. 1a-1e show one example of a schematic for particle printing lithography.

FIG. 2 shows the transfer of micro- and nano-particles onto a conductive portion(s) of a non-conductive support using an electrical force.

FIG. 3 illustrates a simultaneous process for coating the portions of the master pattern to form the template.

FIGS. 4a-4f show an alternate scheme for preparing a product film with a pattern of biomolecule conjugates.

FIGS. 5a-5d show atomic force microscopy (AFM) images of three different types of nanoparticles assembled sequentially onto three 70 nm-wide Pt nanoelectrodes as the boundaries of the characters “1”, “2”, and “3”. The nanoelectrodes are shown as lines, and the nanoparticles are shown as bright dots in the AFM images. The assembled nanoparticles are then transferred from the nanoelectrodes to a polymer film. FIG. 5d shows a scanning electron microscopy (SEM) image of the surface morphology of the polymer film product.

FIGS. 6a-6b show a fluorescence microscopy image (6(a)) and corresponding scheme (6(b)) for the three different types of nanoparticles labeled with red, green, and blue fluorophores that had been sequentially assembled on nanoelectrodes on a stamp; transferred onto a polymer film; and incubated with biotinylated BSA and then streptavidin labeled with orange fluorophore.

FIGS. 7a-7h show the results of the magnetic electric lithography (MEL) process illustrated in Example 2 below. FIGS. 7a-7d show the successive coupling of three different bioconjugates to the letters MEL formed by electrodes on the non-conductive support. FIG. 7e shows that the clean support can be recovered after the bioconjugates are transferred to a polymeric product film. An image of the product film is shown in FIG. 7f and FIG. 7g shows an AFM image after treatment by RIE to bring the bioconjugates to the surface. FIG. 7h diagrams the effect of RIE.

FIGS. 8a and 8b show treating the entrapped biomolecule conjugates in the product film with labeled probes to demonstrate retention of activity. FIG. 8a is a fluorescent microscopy image of the results and FIG. 8b diagrams the labeling of the bioconjugates.

FIGS. 9a-9d show the results of patterning on a nanometer scale using gold electrodes providing labeled polymeric film product alongside a scheme of the process.

FIGS. 10a-10c show the process (FIG. 10a) and resultant images of MEL conducted over a large area (FIGS. 10b, 10c).

FIGS. 11a and 11b show the densities of microparticles that can be obtained as immobilized on a master pattern by applying different voltages and durations.

### MODES OF CARRYING OUT THE INVENTION

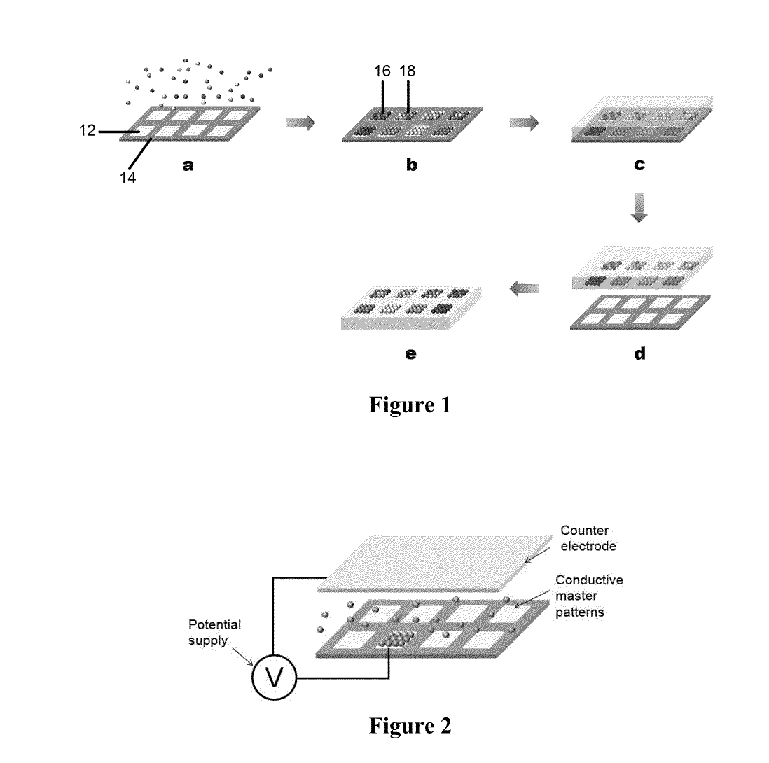

The methods of the invention can conveniently be designated particle printing lithography (PPL). PPL is a micro- and nano-scale lithographic technique for biomolecular patterning. FIG. 1 shows the steps in one embodiment of a generalized PPL process. The support is shown in FIG. 1a as a series of portions 12 formed by art-known processes in any arbitrary master pattern in a support, 14. If the attractive force to be employed is electrical, these portions are conductive regions whereas the remainder of the support is non-conductive and is formed from an insulating material. The portions of the master pattern may also be formed by semi-conducting materials. In some embodiments, a conductive portion may be covered at the top surface with a thin layer of protective insulator provided the electrical force is provided in the correct manner (i.e., using an altering current). If the attractive force is magnetic, the portions of the master pattern are magnetic, and the remaining portions non-magnetic.

Particles coupled to a desired biomolecule, i.e., biomolecule conjugates, contained in a suspension are supplied to the upper surface of the support or “stamp” and a suitable force, e.g., electrical or magnetic, is applied from the portions of the master pattern.

In the embodiment shown in FIG. 1, when a first portion, e.g., 16 is thus coupled to a first particle-conjugated biomolecule, the suspension is removed and a second suspension containing a second biomolecule coupled, typically, to the same type of particle, is provided to the upper surface and the attractive force applied from the underside of a second portion, e.g., 18 desired to be coated. Once again, the force is supplied to the second portion which then becomes coated with the second particle-conjugated biomolecule. This process is repeated with suspensions of third, fourth, fifth, etc., biomolecule-conjugates with the corresponding attractive force applied to each successive portion until all the desired portions are coated with the multiplicity of desired biomolecule-conjugates. The completed template with different biomolecules in the various portions is shown in FIG. 1b.

The template in FIG. 1b is then used to transfer the pattern of biomolecules to a polymer or hydrogel matrix by casting into the template a matrix of an un-crosslinked polymer or hydrogel under conditions wherein the biomolecule-conjugates are transferred into the matrix as shown in FIG. 1c. After crosslinking or other suitable means to condense the matrix into a film, the film is removed as shown in FIG. 1d. The support containing the master pattern can be recovered and used to prepare additional templates.

In one embodiment, the assembly of the particles onto the master patterns on the template can be controlled by applying electric fields on portions of conductivity arranged in a master pattern as diagrammed in FIG. 2. Using magnetic fields may decrease the time required to achieve the result as the gradient can be varied along the lower surface so as to attract or repel the relevant particles.

In another embodiment, magnetic forces are applied. The assembly of the particles onto the master patterns can also be achieved by applying a magnetic field, just as the electrical force can be focused successively on each portion to be coated with each different biomolecule, so too can the magnetic field. The magnetic field on the portions can be selectively activated and deactivated by the local external magnetic field generated by a system such as a magnetic writing head used in the magnetic memory system. The ferromagnetic or paramagnetic particles in suspension on the upper surface of the support can be attracted and immobilized to the portions by the activated magnetic field. The magnetic (ferromagnetic or paramagnetic) particles can also be electrically charged by coating electrically charged molecules on the surfaces of the particles, so a repulsive force between the particles will avoid the formation of the clusters of the magnetic particles. After a single layer of the close-packed desired biomolecules conjugated with magnetic particles is assembled on the selected portions, the electric repulsive force between the charged magnetic particles can avoid assembly of the other magnetic particles on the top of the assembled magnetic particles to avoid mixture of the magnetic particles with different biomolecules. The different biomolecule conjugates may be assembled to the different portions on the said support sequentially by activating the magnetic field on the different corresponding portions.

The magnetic field can also be generated by electrically conductive coils embedded in the support underneath the portion. The magnetic field and its gradient are generated near the coil by passing electric current through the coil. The magnetic particles in the suspension that on the upper surface of the support are thus attracted and immobilized to the portions by the magnetic field or gradient of the magnetic field.

In another embodiment, hydrophilic forces are applied. The support is made to be hydrophobic. The surface wetting property of each portion can be patterned by applying an electric field. When the aqueous liquid containing bioconjugates or biomolecules is applied to the support, the aqueous liquid will go to the hydrophilic portion.

This can be employed in reverse by supplying a hydrophobic liquid containing the desired bioconjugates in an oil or other hydrophobic fluid.

In another embodiment, molecular interactions are applied as attractive forces. Each portion is composed of one type of molecule or molecular combination. These capture molecules can specifically bind to their target complementary molecules in the supplied bioconjugates or biomolecules. The supplied bioconjugates are sorted according to the molecules on each portion. This embodiment employs specific binding pairs such as antigen/antibody, receptor/ligand, or complementary oligonucleotides.

The molecular interactions can be combined with electric or magnetic forces, or hydrophilic or hydrophobic forces. The electric magnetic force or hydrophilic or hydrophobic interaction attracts the bioconjugates to the vicinity of portions containing capture molecules—members of the bonding pairs; then the bioconjugates containing target complementary molecules can be captured by the capture molecules through molecular interactions and immobilized on the portions.

As with the use of electrical forces, the patterning process can be implemented by introducing a first suspension containing a first desired biomolecule conjugate to the upper surface of the support to assemble the biomolecules to a first portion, and then repeated with second, third, etc., suspensions to form patterns of different biomolecules on the different portions on the support. The same implementation can be used when using magnetic force, hydropilic/hydrophobic force, or molecular interaction as attractive force.

As stated above, in either case, by employing appropriate microfluidic techniques, individual suspensions of different bioconjugates may be supplied simultaneously to individual portions of the master pattern and the appropriate force applied to the various portions of the master pattern. The multiple portions of the master pattern can, for example, be controlled by electric circuits embedded in the support. The sizes of the biomolecular patterns can be assembled on the template in parallel over an area range between 100 nm² to 100 cm².

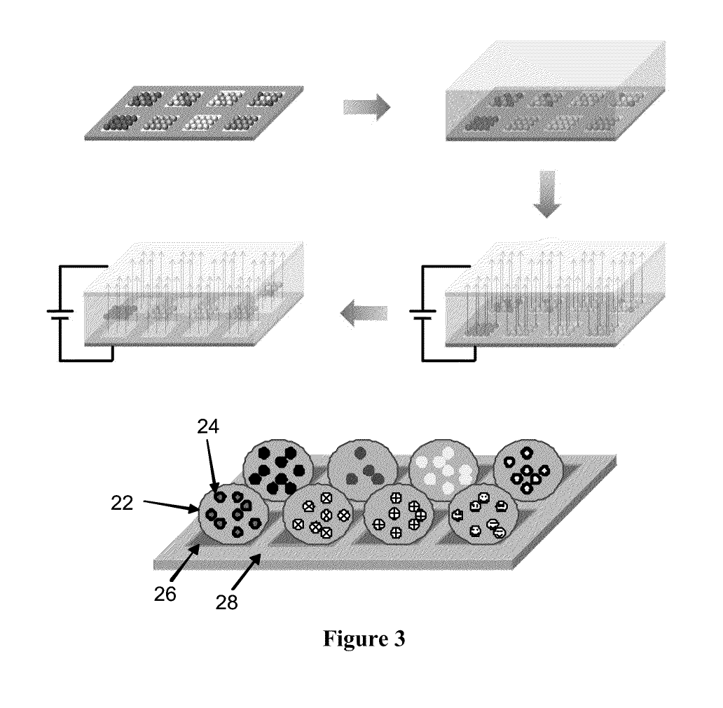

This is illustrated in FIG. 3. Many confined suspensions such as droplets (22) containing different biomolecule conjugates (24) are applied to the upper surface of the support (28) to assemble the different biomolecules in parallel to the selected portions, 26. The location of each confined suspension can be controlled to its desired location simultaneously by using known microfluidic systems. With each confined suspension, the bioconjugates in each confined suspension can be attracted and immobilized to the desired portions by an electric force, a magnetic force, molecular interaction, or the combination of the forces.

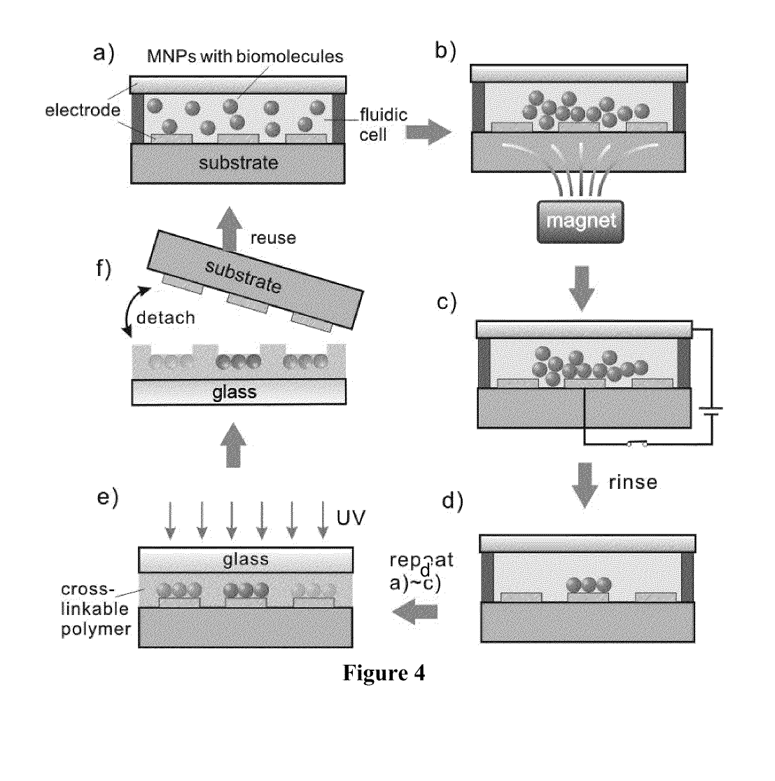

A slight modification of the process described above is found in FIG. 4. As shown in FIG. 4a, the support (labeled “substrate” in the figure) with elevated sections shown as the conductive portions is provided with a suspension of identical biomolecules coupled with magnetic nanoparticles (MNPs) in a fluidic cell above the substrate formed with an electrode as also shown in FIG. 4a. As shown in FIG. 4b, a magnetic field is applied to bring the suspended biomolecule conjugates of a first biomolecule into proximity with the support. In FIG. 4c, an electrical potential is applied to the conductive portion shown in order to couple the biomolecule conjugate specifically to that first portion. After rinsing, the first biomolecule conjugates remain specifically coupled to the desired conductive portion (FIG. 4d). After these steps are repeated using additional different biomolecule conjugates with the electrical potential applied sequentially to the remaining conductive portions on the support, the template shown in FIG. 4e is obtained and covered with a matrix containing a crosslinkable polymer and covered with a glass cover plate. UV light is applied as shown in FIG. 4e and the resulting film is removed as shown in FIG. 4f. This substrate support containing the conductive regions can then be reused in this process.

Transferring bioconjugates to matrix can also be achieved by applying electric fields in a process similar to electrophoresis. A 3D pattern inside the matrix can be obtained using this method. The portions of the template from which transfer is to occur are made with conductive materials. After the bioconjugates are immobilized on the portions, the template is contacted with the matrix which is chemically crosslinked, or physically associated polymer or hydrogel, for example, an agarose gel. The matrix can also be an uncrosslinked or unassociated polymer or hydrogel and subsequently crosslinked or associated. A conductive plate is then added as a counter electrode to generate parallel electric fields in the matrix between the template and the plate. The magnitude and duration of the electric field applied will depend on the pore size of the polymer or the hydrogel, the size of the bioconjugates, and the destination position of the bioconjugates inside the matrix. This system works as a conventional gel electrophoresis apparatus. After transferring, the matrix is removed from the support which can then be reused.

Transferring bioconjugates to matrix can also be achieved by pressing a solid plate onto the template. The bioconjugates or biomolecules then chemically react or physically associated with the solid plate. For example, thiol containing biomolecules react with Au plate to form S—Au bond. The solid plate can then be removed from the template with the bioconjugates or biomolecules attached to it. After transferring, the support can be reused.

As further described below, if the bioconjugates comprise particles or polymers coupled to biomolecules through a cleavable linker, the template can be subjected to a cleavage agent or condition and only the biomolecule portion of the conjugate transferred to the film.

The sizes and shapes of the biomolecule-conjugate patterns are determined by the sizes and shapes of master patterns of the portions that permit effectiveness of the attractive force, i.e., the pattern of relevant portions contained on the support, and by the sizes of the particles.

The pattern of the biomolecules themselves also depends on the size and shape of the particles to which they are conjugated and the number of biomolecules contained on each particulate support.

The distribution of the densities of the distinct biomolecules assembled on each master pattern is determined by controlling the assembly conditions such as the concentrations and types of the distinct particles in the solution, and the duration and magnitude of the assembly forces.

As used herein, the term “substrate” or “support” refers to the material that forms the supporting platform corresponding, for example, to 14 in FIG. 1a. In general, the support comprises areas that are not responsive to the attractive force to be supplied—i.e., are non-conductive in the case of electrical forces, are non-magnetic or protected magnetic regions in the cases of magnetic forces, are hydrophobic in the case of hydrophilic attraction, or hydrophilic in case of hydrophobic attraction, contain no capture molecule in case of molecular interaction. As noted above, in some instances, for larger scale template production using magnetic fields, the position of the application of the magnetic field itself may supply the relevant master pattern.

“Master pattern” refers to the pattern of portions responsive to the attractive force displayed on or within an upper surface of the support or substrate, in which one or more attractive force can be applied to attract and immobilize the bioconjugates from the suspension.

Portions on the support to which an electrical force, an electrostatic force, an electrophoretic force, an electromagnetic force can be applied are made from conductive materials including but not limited to Au, Pt, Ag, Ti, Si, TiO₂, or semiconductors including but not limited to Si, Ge, GaAs and GaN. Portions on the support to which a magnetic force can be applied are themselves magnetic and composed of, for example, Fe₃O₄, Co, Ni, Dy, Gd or NIB. Portions on the support in which hydrophilic interactions occur are coated with hydrophilic materials such as polyethylene glycol (PEG) or hydrophilic proteins. The portions can also be made hydrophilic by patterning certain nanopatterns on it. Portions that provide for hydrophobic interaction are coated with hydrophobic materials such as waxes or Teflon®. Portions on the support where molecular interaction occurs are made by immobilizing the capture molecules on the portions by chemical or physical bonding.

The support itself, where the force is electrical, may be constructed of, for example, SiO₂ and Si₃N₄ or other insulators. Use of magnetic force requires a support made by non-magnetic material, such as insulators (SiO₂, Si₃N₄), metals (Au, Pt), semiconductors (Si, GaN), or polymers (PMMA, PDMS). Use of hydrophilic interaction requires a support made with hydrophobic material such as PDMS, Teflon®, or coated with hydrophobic molecules. This pattern may also be used to take advantage of hydrophobic interactions by use of hydrophobic solvents for the bioconjugate.

The sizes in the portions of the master pattern range between 1 nm to 1 cm. The master patterns on the template surface can be made from lithographic techniques including but not limited to optical lithography, X-ray lithography, e-beam lithography, imprint lithography, ion-beam lithography, dip-pen lithography, contact printing lithography, nanografting lithography, etc, or self-assembly techniques.

“Biomolecule conjugate” or “conjugated biomolecule” or “bioconjugate” refers to a molecule of interest coupled to an appropriate microparticle or nanoparticle. The “biomolecule” should be understood to include not only molecules that occur in nature, but also any organic molecule of interest. The term “bio” molecule is used for convenience as in most (but not all) applications, the molecules concerned will be those that either occur in nature or are relevant to interacting with biological systems.

The biomolecules assembled onto the particles include DNA, RNA, proteins, antibodies, antigens, drug molecules, and any other organic molecules of interest.

The micro- or nanoparticles may be composed of a variety of materials and may range in size from 1 nm-100 μm. For most biological applications, the particles will be in the range of 10-600 nm. A variety of particles is well known in the art, including magnetic particles, metal particles, oxide particles, complex particles with core/shell structure, biomolecular particles, virus, cells, liposomes, perfluorocarbon particles, etc. Microparticles include microspheres, microbeads and any particles measured on a micro scale regardless of shape. Nanoparticles include nanospheres, nanocrystals, nanorodes, nanburgers, and the like, i.e., any particles measured on a nanoscale regardless of shape, and quantum dots.

Biomolecules can be conjugated with ferromagnetic or paramagnetic particles made by magnetic materials (e.g., Fe₃O₄, Co, Ni, Dy, Gd, NIB), wherein when the size of the magnetic particles are reduced below a critical value, the ferromagnetic particles become paramagnetic particles. The magnetic (ferromagnetic or paramagnetic) particles can also be electrically charged by coating electrically charged molecules on the surfaces of the particles, therefore the electrical repulsive force between the particles will avoid the formation of the clusters of the magnetic particles due to the attractive magnetic force between the particles.

The micro- or nanoparticles for use in the invention may be coupled only to a single biomolecule, to a multiplicity of identical biomolecules, or to a multiplicity of different biomolecules. In some cases the desired property to effect attraction to the conductive portion may be provided by the biomolecule itself or by coupling the biomolecule with a charged substance other than the particle. For example, DNA is negatively charged at neutral pH.

The micro- or nanoparticles of the invention may be coupled to a biomolecule through a linker. The linker is typically bifunctional having a functional group for coupling directly to the substrate and a functional group for coupling to the biomolecule. Means for coupling biomolecules to particles through such linkers are well known and linkers are commercially available, for example, from Pierce Chemical Company. The linkers may include a cleavage site so that if desired, the biomolecules may be released, for example, during the process of transferring the pattern of the template onto a film for further use. Thus, the bioconjugates may themselves be transferred, or the biomolecules may be cleaved and transferred absent the particles. Cleavage sites include those susceptible to light, those susceptible to pH value, and those susceptible to enzyme cleavage. Thus, the linker might be a peptide containing a cleavage site for trypsin or a polysaccharide containing a cleavage site for a specific polysaccharide hydrolysis enzyme. Other cleavage sites independent of enzymes, pH value, or light may include those specifically cleavable chemically, such as disulfide bonds which are cleavable with reducing agents. A variety of such sites is available for use in the invention.

It should be noted that in some embodiments biomolecular may be used without the need to couple them to particles. In the general description herein, “bioconjugate” includes both biomolecules alone and biomolecules coupled to particles. This simplification is to avoid excess verbiage; as that it is not necessary always to say “bioconjugate or biomolecule.”

“Template” refers to the completed arrangement of biomolecule conjugates on the upper surface of the support according to the master pattern thereon, such as shown in FIG. 1b or FIG. 4e.

“Matrix” refers to an un-crosslinked polymer or hydrogel composition used to obtain the transferred pattern from the template to produce ultimately the “product film” which reflects the master pattern populated with biomolecule conjugates and which then may be used in various assays. In general, “product film” refers to this useable result of the invention method.

The crosslinkable matrix can be polymers or hydrogels made from poly(ethylene glycol) (PEG), poly(methyl methacrylate) (PMMA), polydimethylsiloxane (PDMS), hyaluronic acid (HA), gelatin, polysaccharides such as agarose, etc. The polymers or hydrogels are cast onto the template, and cross-linked, for example, by UV exposure, thermal curing, physical association, or chemical reaction. After the crosslinking, the polymers or hydrogels entrap the patterned biomolecule conjugates. When the cross-linked polymer or hydrogel product films are peeled off from the template, the patterned biomolecule conjugates are removed from the template to the product film. The master patterns on the support can thus be reused repeatedly.

The matrix can be organic or inorganic molecules that can bond with biomolecule conjugates in the template, such as glasses, amorphous materials, insulators, metals or semiconductors.

In an illustrative example, similar to the sequence in FIG. 4, and described in more detail in Example 2 below, various DNA oligos coupled to streptavidin are each conjugated with magnetic nanoparticles to form conjugates. The surface potential of the particles can be measured by dynamic light scattering or other size measuring techniques. As the DNA/particle conjugate is negatively charged, a positive potential is needed to assemble and immobilize the conjugates.

During the assembly and immobilization step, the assembly speed and density of conjugates can be controlled. The first of conjugate DNA/particle conjugate, is delivered to the master pattern at the upper surface of the support by a fluidic channel. A magnetic field is generated to bring the conjugates to the vicinity of master pattern. This short step increases the local concentration of the conjugates. The magnetic field is then removed, and an electrical potential (usually +1.0V˜2.1 V vs. counter electrode if using two-electrode system, or +0.7V˜2.1 V vs. reference electrode if using three-electrode system) is applied on a first conductive portion of the master pattern for 40-600 s to immobilize the conjugate. The larger the electrical potential and the longer the time duration, the higher the density of the conjugate immobilized on master patterns. Excess conjugate is removed by washing. The second DNA particle conjugate is then delivered to the master pattern area, the magnetic concentration is repeated, and these conjugates immobilized to a second portion of the master pattern. Hybrid portions can also be made if both types of conjugates are immobilized to the same portion. Excess conjugate is removed by washing. The aforementioned steps are repeated until all the portions contain immobilized pre-designed conjugates.

Once the assembly process is finished, all the biomolecule-conjugates can be transferred to a polymer or hydrogel, such as the hydrogel formed by PEG-DA (polyethylene glycol diacrylate) and PBS buffer containing, e.g., 1% photoinitiator. The hydrogel concentration can be controlled by varying the percentage of the two components. The hydrogel solution is cast onto the master pattern with the immobilized biomolecule-conjugates. By irradiation with UV, the polymer is crosslinked within 10 s. The crosslinked film is peeled off from the master pattern, leaving the clean pattern for the next use.

As noted above, the complete biomolecule conjugates may be transferred to the film or, if desired, the biomolecules may be cleaved from the particles in only the biomolecules transferred.

Some of the advantages of the present invention are that heterogeneous biomolecular nanopatterns can be generated with high speed, high throughput, high resolution and low cost, and can employ all kinds of biomolecules, such as proteins, nucleic acids, small molecules. The process is substantially independent of the nature of the biomolecules. Therefore, no special protocol is needed for each different set of biomolecules and can employ a large variety of materials, depending on the desired applications.

The biomolecular patterns may contain distinct biomolecules, ranging between 2 to 10⁷ different kinds of biomolecules, and can generate biomolecular patterns with a high speed. The assembly process can be completed within 0.1 s to 10 hours.

The following examples are offered to illustrate but not to limit the invention.

### Example 1

### Materials

Metal nanoelectrodes with a width of ≈70 nm were fabricated by e-beam lithography on a 100 nm-thick SiO₂ layer on a 1 inch×1 inch Si stamp. The nanoelectrodes composed of 20 nm-thick Pt (top) and 5 nm-thick Ti (bottom) layers were deposited by e-beam evaporation. The electric connections with the nanoelectrodes were established by microscale Pt/Ti metal wires fabricated by optical lithography on the same substrate. The metal connection wires were covered with a 300 nm thick SiO₂ insulating layer by plasma-enhanced chemical vapor deposition (PECVD). To prevent nonspecific binding of nanoparticles to the SiO₂ surface on the stamp, PEG silane was grafted onto the SiO₂ surface by incubating the stamp in a silane solution consisted of 0.5% methoxy(polyethyleneoxy) propyltrimethoxysilane (SIM6492.7, Gelest, Inc.) and 0.05% triethylamine in anhydrous toluene in a desiccator for 1 h. To remove excess PEG silane on the stamp surface, the stamp was rinsed with toluene for 2 min, and sonicated in a toluene bath for 1 min. The stamp was rinsed consecutively with isopropanol and DI water for 30 s, and finally dried by blowing with nitrogen.

Five different types of negatively charged polystyrene nanoparticles were used:

Type I: 40 nm nanoparticles coated with streptavidin and labeled by green fluorophores with excitation/fluorescence peak wavelengths at 505 nm/515 nm (F8780, Invitrogen);

Type II: 40 nm nanoparticles coated with biotin and labeled by green fluorophores with excitation/fluorescence peak wavelengths at 505 nm/515 nm (F8766, Invitrogen);

Type III: 20 nm nanoparticles labeled by red fluorophores with excitation/fluorescence peak wavelengths at 580 nm/605 nm (F8786, Invitrogen), and coated with DNA sequence 5′-AAAAAAAAAAAAGGGGGGGGGGGG-3′;

Type IV: 54 nm nanoparticles labeled by red fluorophores with excitation/fluorescence peak wavelengths at 660 nm/690 nm (FS02F-7102, Bangs Laboratories, Inc.);

Type V: 60 nm nanoparticles labeled by blue fluorophores with excitation/fluorescence peak wavelengths at 360 nm/420 nm (FS02F-2598, Bangs Laboratories, Inc.).

### Method and Results

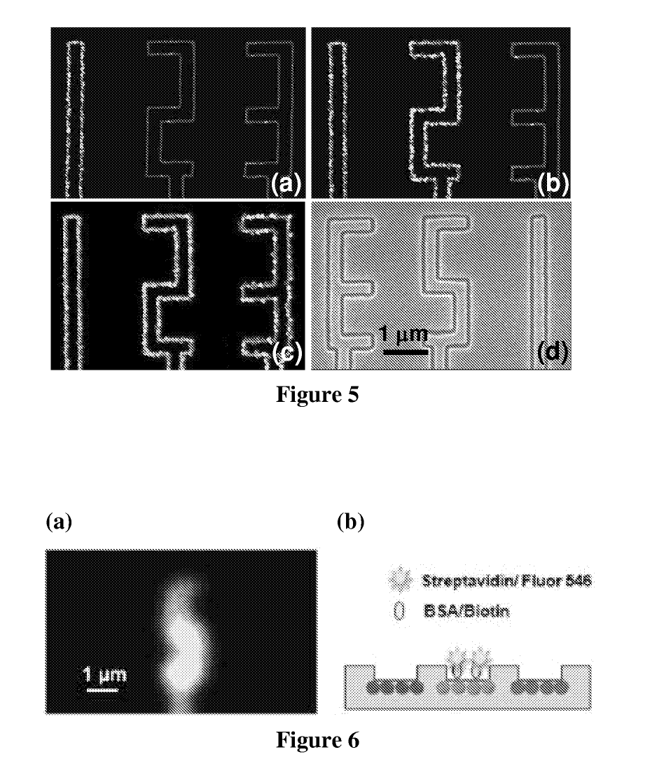

In this example, the metal electrodes (portions) were arranged on the stamp as shown in FIG. 5. For the nanoelectrodes forming numeral 1, Type IV nanoparticles labeled by red fluorophores were diluted in deionized water at a concentration of 0.1% by weight and applied to the upper surface. A voltage of 1.7-1.9 V was applied to the nanoelectrodes forming the numeral 1 for 90 s to assemble the nanoparticles. Nanoparticles of Type I having green fluorescence and streptavidin were similarly applied to form numeral 2 and Type V nanoparticles containing a blue fluorophore were applied similarly to form numeral 3. FIGS. 5a-5c show atomic force microscopy (AFM images) of the successively deposited nanoparticles.

The nanoparticle/biomolecule patterns were then printed from the stamp to a polyethylene glycol diacrylate (PEG-DA) polymer film by immersing the stamp surface in the PEG-DA solution (n=400, Polysciences, Inc.) covered by a glass substrate. This solution consisted of 80% PEG-DA, 17% phosphate buffered saline, pH 7.4, 0.01 M, 2% bis (2,4,6-trimethyl-benzoyl)-phenylphosphineoxide (Irgacure™ 819, Ciba) as a photoinitiator and 1% Tween 20 as surfactant. The PEG-DA solution was cured by UV light with a UV intensity of 11.0 mW cm⁻² for 4 s. The fluorescence images were taken using a fluorescence microscope (Nikon Eclipse E400) with different filter sets. The nanoscale structures were observed by an AFM (Digit Instruments Dimension 3100) and an SEM (JEOL S-4300).

After the polymer solution was cured, the nanoparticles were transferred to the solidified PEG-DA file by peeling off the polymer film from the stamp. The AFM image of the transferred image is shown in FIG. 5d.

The streptavidin coupled to the particles that form numeral 2 was still active. The PEG-DA film was soaked in 30 μg/ml biotinylated BSA (more than 8 mol biotin per mol BSA) (29130, Pierce) in a 0.01 M PBS solution for 30 min. After rinsing, the film was incubated in a PBS solution consisting of 10 μg/ml orange Alexa Fluor®-546 coupled to streptavidin (with excitation/fluorescence peak wavelengths at 546 nm/573 nm), 0.1% BSA and 0.02% Tween 20 for 30 min.

In FIG. 6, the results of treating the transferred image with BSA/biotin and streptavidin/Fluor®-546 are shown, wherein the biomolecules contained in the numeral 2 are reactive. The blurred fluorescence images and the low fluorescence signal/background noise ratios are mainly due to the resolution limitation of the fluorescence microscope.

Thus, the results confirm that streptavidin remains active.

### Example 2

### Materials

Water-soluble iron oxide (Fe₃O₄) magnetic nanoparticles (MNPs) with an average diameter of approximately 10 nm were synthesized and capped with positively charged 2-pyrrolidinone (Li, Z., et al., Chem. Mater. (2004) 16:1391-1393), and a negatively charged poly(styrene sulfonate) (PSS) layer was then self-assembled onto the MNPs (Schneider, G., Nano Lett.) 2004) 4:1833-1839). Streptavidin was physically adsorbed to the PSS-coated MNPs (Norde, W., et al., J. Colloid Interface Sci. (1979) 71:350-366), and three different biotinylated DNA oligonucleotides (S1, S2, and S3, Table 1) were conjugated with the streptavidin on the MNPs.

TABLE 1
DNA sequences used in this study.

| | | λ ex^{[a]}/em^{[b]} |
|---|---|---|
| Code | Sequence | [nm] |
| S1 | 5′-biotin-T₁₅GCTTATCGAGCTTTCG-3′ | |
| S2 | 5′-biotin-T₁₅ATCGATCGAGCTGCAA-3′ | |
| S3 | 5′-biotin-T₁₅ATCAGTGCAGGAGCTA-3′ | |
| F1 | 5′-TEX613-CGAAAGCTCGATAAGC-3′ | 596/613 |
| F2 | 5′-FAM-TTGCAGCTCGATCGAT-3′ | 495/520 |
| F3 | 5′-Cy3-TAGCTCCTGCACTGAT-3′ | 550/564 |

^{[a]}The maximum excitation wavelengths.
^{[b]}The maximum emission wavelengths.

The cross-linkable polymer solution for MNP transfer contains 66 wt % poly(ethylene glycol) diacrylate (PEG-DA, n=400), 3.0 wt % 2-hydroxy-4-(2-hydroxyethoxy)-2-methylpropiophenone as photoinitiator, 30 wt % phosphate-buffered saline (PBS), and 1 wt % surfactant (Tween 20). The PEG polymer solution was cross-linked by UV exposure with an intensity of 11.0 mW cm⁻² for 30 seconds to form PEG hydrogel. After the MNPs were transferred to the PEG polymer substrate, complementary DNA strands (F1, F2, and F3, Table 1) were hybridized with the DNA (100 nM) on the MNPs in a buffer solution (1 M NaCl, 10 mM 2-amino-2-hydroxymethyl-propane-1,3-diol (tris) HCl, 1 mM ethylenediamine tetraacetic acid (EDTA), and 0.01% (w/v) sodium dodecyl sulfate (SDS), pH 7.4) at room temperature (25° C.) for 1 h. The biotin was conjugated with the streptavidin on the MNPs in a solution of 10 μg ml⁻¹ biotin in PBS solution for 1 hour.

Method and Results

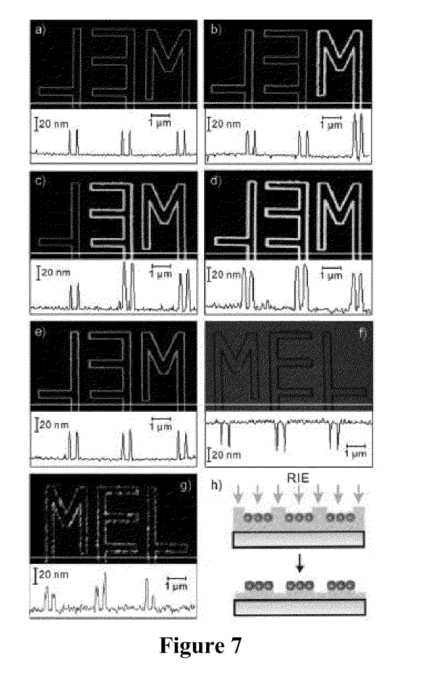

Gold nanowire electrodes were used to form the boundaries of the letters M, E and L on a SiO₂ surface (FIG. 7a). By sequential application of a 1.5 V potential to the “M”, “E”, and “L” nanoelectrodes, MNPs coated with three distinct DNA oligonucleotides (S1, S2, and S3) were sequentially immobilized onto the nanoelectrodes as shown in FIGS. 7b-d. As measured by AFM, the nanoelectrodes assembled with the MNPs are approximately 20 nm higher than those without MNPs, and there was no obvious immobilization of MNPs beyond the nanoelectrodes to which the electrical potential was applied.

After the MNPs were transferred to the PEG polymer substrate as described above, the AFM image of the template surface (FIG. 7e) showed that the nanoelectrodes had recovered to the original morphology, and the MNPs had been completely transferred to the polymer product film.

The template surface morphology was faithfully embossed onto the polymer product film (FIG. 7f). After the polymer was selectively etched by reactive ion etching (RIE), the MNPs buried underneath the polymer surface were extruded (FIGS. 7g, h), showing the nanopatterns formed by the MNPs.

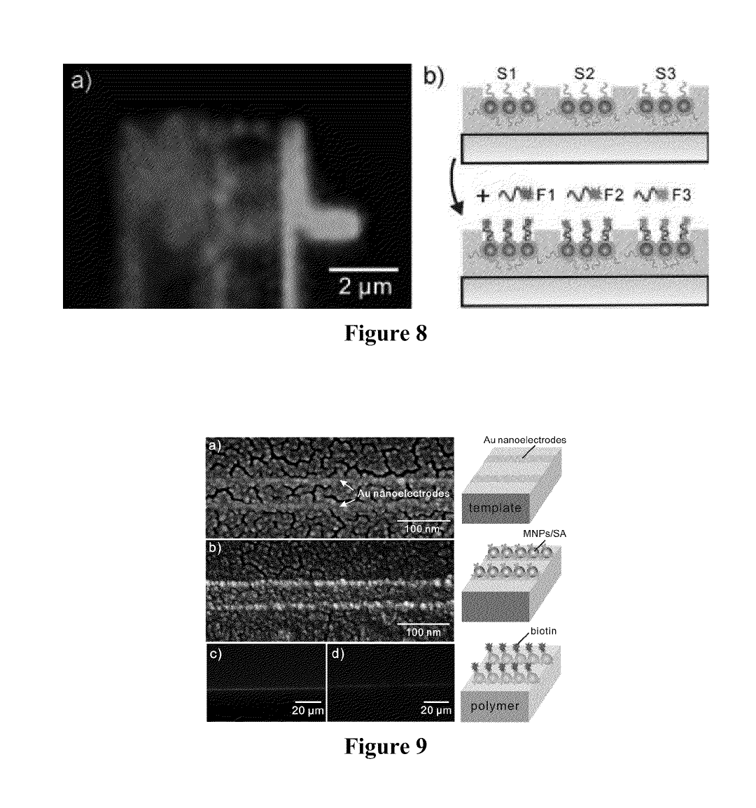

The bioactivity and specificity of the biomolecular nanopatterns on the polymer substrate was demonstrated by exposing the polymer substrate to a mixed solution of three different fluorophore-labeled DNA oligonucleotides (F1, F2, and F3 in Table 1) that are complementary to the aforementioned S1, S2, and S3 DNA strands coated on the MNPs. A superimposed fluorescence image of the complementary DNA nanopatterns after DNA hybridization is shown in FIG. 8a. Although the fluorescent nanopatterns are blurred owing to the resolution limit of the fluorescence microscope, the image still indicates the specific hybridization between the DNA strands and the reactivity and specificity of the DNA on the MNPs (FIG. 8b).

### Example 3

To demonstrate the high resolution of magnetic electric lithography (MEL), a template consisting of two parallel 8 nm wide Au nanoelectrodes was fabricated on a SiO₂ surface. Streptavidin-coated single MNPs with a diameter of approximately 10 nm were immobilized and aligned in a row along the Au nanoelectrodes. The MNPs were coated with streptavidin labeled with green fluorophores (Alexa Fluor®-488); therefore, a green fluorescent line can be observed along the nanoelectrodes by the fluorescence microscope, but the double nanoelectrodes cannot be distinguished owing to the limitation of the microscope resolution. After the MNPs were transferred to a PEG polymer substrate, the streptavidin units on the MNPs were treated with biotin labeled with a red fluorophore (Atto-590). A red fluorescent line can then be observed along the nanoelectrodes. The experimental results indicate that MEL can generate biomolecular nanopatterns with a resolution down to approximately 10 nm. The resolution is defined by the sizes of the MNPs and of the nanoelectrodes on the template. This is illustrated in FIGS. 9a-d.

### Example 4

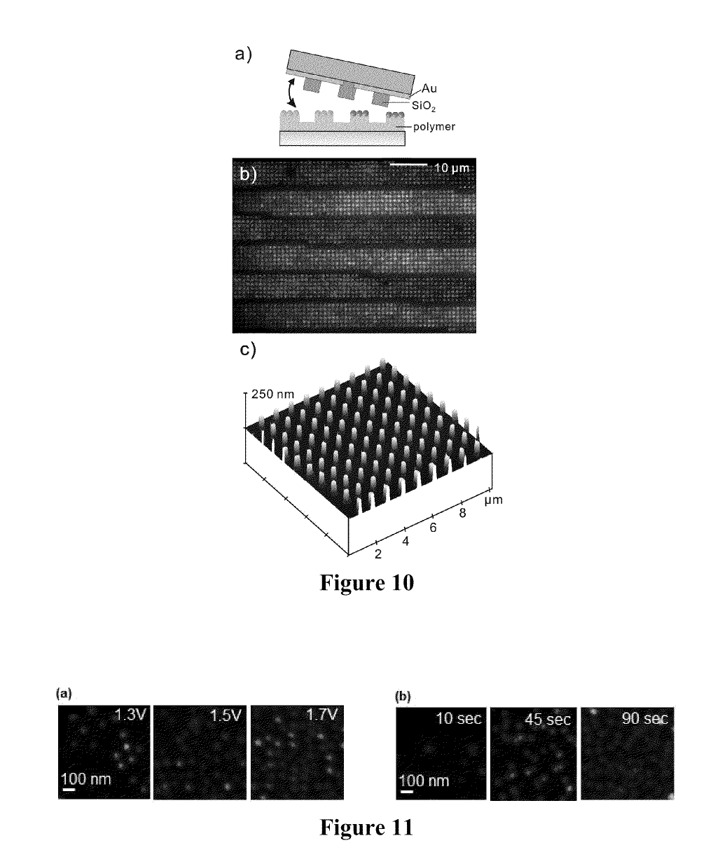

To explore biomolecular nanopatterns by a parallel MEL process over a large area, a template was fabricated with an array of nanoholes through a SiO₂ layer over an area of approximately 0.5 cm², and microscale Au electrodes buried underneath the SiO₂ layer were exposed to the template surface through the nanoholes (FIG. 10a). Different MNPs coated with streptavidin labeled with a red (Alexa Fluor®-594) or a green (Alexa Fluor®-488) fluorophore were delivered to the template surface through the microfluidic system. A 1.5 V potential was applied for five seconds on the Au electrodes to immobilize the different MNPs onto the different Au electrodes through the SiO₂ nanoholes over the whole template surface in parallel. The MNPs were then transferred to a PEG polymer substrate. Fluorescence and AFM images of the MNP nanoarray on the polymer substrate are shown in FIGS. 10b, c, which indicates that heterogeneous biomolecular nanoarrays can be facilely fabricated over a large area by a parallel MEL process.

### Example 5

During the electrophoretic deposition of nanoparticles onto nanoelectrodes on a stamp surface, the density of the nanoparticles assembled on the surfaces of the nanoelectrodes can be modified by adjusting the magnitude and duration of the potential applied on the electrodes. For example, the streptavidin-coated polystyrene nanoparticles were assembled on Pt nanoelectrodes. In FIG. 11 (left), the voltages applied on the electrodes were set at 1.3 V, 1.5 V, and 1.7 V for a fixed duration of 90 s. In FIG. 11 (right), the voltage applied on the electrodes are fixed at 1.7 V for durations of 10 s, 45 s, and 90 s. The surface densities of the nanoparticles assembled on the electrode surfaces under the various conditions were examined by AFM. As shown in FIG. 11, the nanoparticle density increases monotonically when the amplitude or duration of the applied potential increases.

### Example 6

Bioconjugates are prepared by adding 3.6 μl of a plasmid for expression of EGFP (1 mg/ml), 13 μl linear PEI (1 mg/ml) to 65 μl DI water, and mixing by sonication. The hydrodynamic diameters of the conjugates are around 30 nm measured by Zeta nanosizer. The surface potential of the conjugates is around +30 mV.

The bioconjugates (EGFP plasmid/PEI polyplexes) were assembled and immobilized on an Au electrode. Uncured PDMS (RTV-615 A:B=10:1, General Electric) was cast on the chip. Once cured, polyplexes were transferred to PDMA and the PDMS film was peeled off. The PDMS was coated with fibronectin and cells are grown on the surface of PDMS. After 48 hours, the cells grew only on the polyplexes showing bright green fluorescence, from the expressed GFP proteins.

1. A method to prepare a template which template comprises a support having a top surface and a bottom surface and having a multiplicity of portions arranged in a master pattern, said multiplicity of portions coated with a multiplicity of different biomolecules, which method comprises
(a) contacting each portion of the master pattern with a suspension of bioconjugates, said bioconjugates composed of a biomolecule or multiple biomolecules optionally coupled to a microparticle or nanoparticle, wherein said bioconjugates respond to an attractive force when said force is applied to or is intrinsic to said portion and wherein the bioconjugates in the suspension are different for different portions;
(b) if needed, applying said attractive force to each said portion to associate each different bioconjugate in the suspension with a corresponding portion;
so as to populate said multiplicity of portions with a series of different biomolecules.

2. The method of claim 1 wherein said bioconjugates respond to said attractive force by virtue of a characteristic of the nanoparticle or microparticle.

3. The method of claim 1 wherein the bioconjugates respond to the attractive force by virtue of a characteristic of the biomolecule.

4. The method of claim 1 wherein said attractive force is an electric force, and wherein said support is a non-conductive support composed of insulating material and said portions of the master pattern comprise conductive or semiconductive material.

5. The method of claim 1 wherein the attractive force is a magnetic force, and wherein said support comprises magnetic material and protective non-magnetic material and wherein said portions comprising the master pattern do not comprise an effective amount of the protective material.

6. The method of claim 5 wherein only said portions comprising the master pattern comprise magnetic material, or
wherein the magnetic attractive force is generated by electric current only on said portions comprising the master pattern.

7. The method of claim 1 wherein the attractive force is a hydrophilic force, and wherein the surface of said support is hydrophobic and the surface of the portions to which bioconjugates are to bind are hydrophilic.

8. The method of claim 1 wherein the attractive force is a hydrophobic force, and wherein the surface of said support is hydrophilic and the surface of the portions to which bioconjugates are to bind are hydrophobic

9. The method of claim 1 wherein the attractive force is bonding force between the bioconjugates and the portions to which the bioconjugates are to bind.

10. The method of claim 1 wherein suspensions of bioconjugates are applied to each portion separately through a microfluidic control system, and the attractive force is applied to all the portions on the support simultaneously, whereby the bioconjugates are associated with the corresponding portions.

11. The method of claim 1 wherein said method comprises
(a) contacting the top surface of said support with a first suspension of a first bioconjugate, said bioconjugate composed of a first biomolecule optionally coupled to a microparticle or nanoparticle, wherein said bioconjugate responds to an attractive force when said force is applied or is present from a first conductive portion;
(b) if necessary, applying said attractive force to the bottom surface of said first portion to associate said first bioconjugate with said first portion;
(c) removing said first suspension; and
(d) repeating steps (a)-(c) successively with additional suspensions of different bioconjugates with respect to each of the remaining portions.

12. A template prepared by the method of claim 1, 10 or 11.

13. A method to prepare a product film containing a pattern of different biomolecules in a film which method comprises
(a) providing the template of claim 10;
(b) casting a matrix onto the top surface of said template;
(c) transferring the bioconjugates to the matrix to obtain a film;
(d) removing said film from the top surface of the template.

14. The method of claim 13 wherein the matrix is an uncrosslinked polymer and wherein the polymer is cross linked after the bioconjugates are transferred.

15. The method of claim 13 which further includes applying an electric field is applied across the template and matrix.

16. A product film prepared by the method of claim 13.

17. The method of claim 1 which further comprises
(a) casting an un-crosslinked matrix onto the top surface of said template;
(b) crosslinking said matrix to form a film; and
(c) removing said product film from the top surface of the template.

18. The method of claim 1 which further comprises
(a) casting an crosslinked matrix onto the top surface of said template;
(b) applying an electric field to attract the bioconjugates to the matrix and immobilize the bioconjugates at the desired positions to form a film; and
(c) removing said film from the top surface of the template.

19. The method of claim 1 which further comprises (1) pressing a solid matrix onto the top surface of said template;
(2) the bioconjugates react with the matrix; and
(3) removing said matrix from the top surface of the template.

20. A product film prepared by the method of claim 18 or product matrix prepared by the method of claim 19.
